(19) United States
(12) Patent Application Publication
(10) Pub. No.: US 2014/0059378 A1
(43) Pub. Date: Feb. 27, 2014

(54) METHOD OF SYSTEM RECOVERY OF CLIENT DEVICE, WIRELESS CONNECTION DEVICE AND COMPUTER PROGRAM

(71) Applicant: Buffalo Inc., Nagoya-shi (JP)

(72) Inventor: Hideki ISHII, Nagoya-shi (JP)

(73) Assignee: Buffalo Inc., Nagoya-shi (JP)

(21) Appl. No.: 13/968,891

(22) Filed: Aug. 16, 2013

(30) Foreign Application Priority Data
Aug. 27, 2012 (JP) 2012-186260

(51) Int. Cl. G06F 11/14

(52) U.S. Cl. CPC G06F 11/1412
USPC 714/15

(57) ABSTRACT

The present disclosure provides a technique of easily enabling recovering of a client device via wireless communication. In one embodiment, the configuration includes a wireless connection device that establishes wireless communication with the client device; obtains restoration data that is stored in advance in a specified storage; and sends the obtained restoration data via the wireless communication to the client device.

### CROSS REFERENCE TO RELATED APPLICATION

The present application claims priority to Japanese Patent Application No. 2012-186260 filed on Aug. 27, 2012, the disclosure of which is hereby incorporated by reference in its entirety.

### FIELD OF THE DISCLOSURE

The present disclosure relates to a technology of system recovery of a client device.

### DESCRIPTION OF THE RELATED ART

On the occurrence of a failure in a client device such as a personal computer, an external storage medium provided in advance for system recovery may be used to recover the operating environment of the client device to the state before the occurrence of the failure. The specialized knowledge has been required for the recovery of the client device, so that the user who is unfamiliar with the computer often has difficulty in recovery. With the spread of the personal computers, however, there is a demand enabling the user who is unfamiliar with the computer to recover the client device easily.

Some techniques have been proposed to enable the recovery of the client device. One proposed technique generates data for recovery of the client device in a specific recovery area of a server connected with the client device via a wired network and performs the recovery of the client device via the wired network. Another proposed technique uses a backup server connected with the client device via a wired network to perform the recovery of the client device. Yet another proposed technique uses a watcher device and a manager device in a LAN to perform the version upgrade and the recovery of the system of the client device.

The above proposed techniques, however, require a separate backup server or a manager device in the system. These proposed techniques accordingly still have a problem of non-easiness of system recovery. None of the proposed techniques also has taken into account the system recovery via a recently popular wireless network.

There is accordingly a need for the technique that enables easy system recovery of a client device via wireless communication.

### SUMMARY

The present disclosure is made to solve at least part of the foregoing and may be actualized by any of the following aspects and embodiments.

According to one aspect of the disclosure, there is provided a wireless connection device. the wireless connection device comprising: circuitry configured to establish wireless communication with a client device connected with the wireless connection device; obtain restoration data that is stored in advance in a specified storage, wherein the restoration data is for system recovery of the client device; and send the obtained restoration data via the wireless communication to the client device.

The disclosure may be implemented by any of various applications other than the method of system recovery: for example, a system recovery device that enables the method of system recovery, a control method of the system recovery device, a computer program configured to implement part or all of the method of system recovery, and a non-transitory storage medium in which such a computer program is recorded.

### BRIEF DESCRIPTION OF THE DRAWINGS

FIG. 1 is a diagram illustrating the schematic configuration of a network system using a wireless network device according to one embodiment of the disclosure;

FIG. 2 is a diagram illustrating the schematic configuration of an AP;

FIG. 3 is a diagram illustrating the schematic configuration of a PC;

FIG. 4 is a sequence diagram showing a procedure of restoration data generation process;

FIG. 5 is a sequence diagram showing a procedure of recovery process; and

FIG. 6 is a diagram illustrating the schematic configuration of a client device and a wireless connection device according to a third embodiment.

### DESCRIPTION OF PREFERRED EMBODIMENTS

The following describes embodiments of the present disclosure with reference to the accompanied drawings.

### A. First Embodiment

A-1. Schematic System Configuration

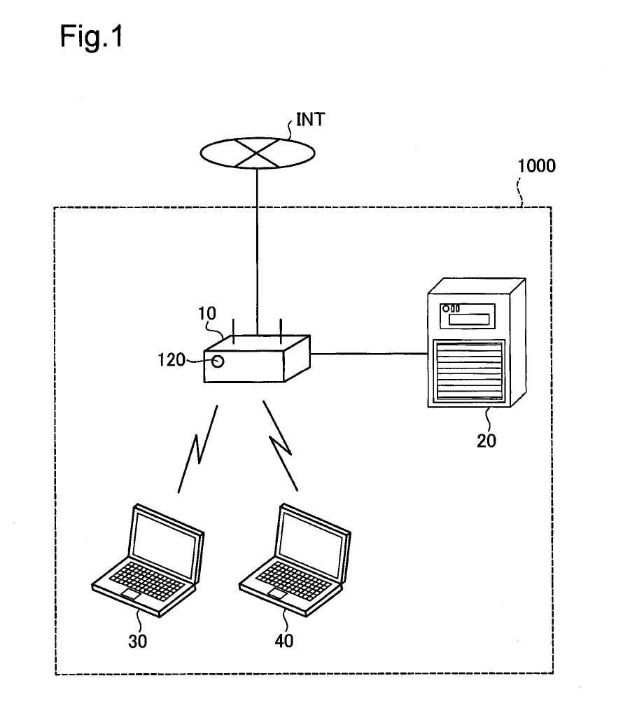

FIG. 1 is a diagram illustrating the schematic configuration of a network system using a wireless network device according to one embodiment of the disclosure. The network system 1000 includes a wireless network device 10 serving as a wireless connection device, a network attached storage 20 and two client devices 30 and 40.

The wireless network device 10 according to this embodiment is an access point device in conformity with the IEEE 802.11 standard. In the description hereafter, the wireless network device is also simply called “AP”. The AP 10 serves to relay wireless communication with the client devices 30 and 50. The AP 10 is connected via LAN with the network attached storage 20 by a cable. The AP 10 serves to relay communication between the network attached storage 20 and the client devices 30 and 40. According to this embodiment, the AP 10 also serves as a router and is connected to the Internet INT by a cable.

The AP 10 according to this embodiment supports a restoration data generation process. The restoration data generation process causes one or more client devices connected with the AP 10 (client devices 30 and 40 in the illustrated example) to obtain their backups in advance. The AP 10 also supports a recovery process. The recovery process is performed on the occurrence of a failure in a client device to use its backup obtained in advance and thereby restore the operating environment of the failed client device to the environment prior to the occurrence of the failure. Restoring the operating environment of the failed device to the environment prior to the occurrence of the failure is also called “recovery” in the description hereof. The AP 10 has a setup button 120 used as the trigger to start the recovery process. The details of the restoration data generation process and the recovery process will be described later.

The network attached storage 20 according to this embodiment is a storage device connectable with a network. In the description hereafter, the network attached storage is also simply called NAS. The NAS 20 includes a CPU, a hard disk drive, a wired communication interface, a ROM and a RAM. The wired communication interface of the NAS 20 is connected with the AP 10. The hard disk drive of the NAS 20 may store various user data including audio data, image data and application data, as well as the restoration data generated in the restoration data generation process.

The client devices 30 and 40 according to this embodiment are personal computers equipped with wireless communication interfaces in conformity with the IEEE 802.11 standard. In the description hereafter, the client device is also simply called “PC”.

A-2. Schematic Configuration of Wireless Network Device

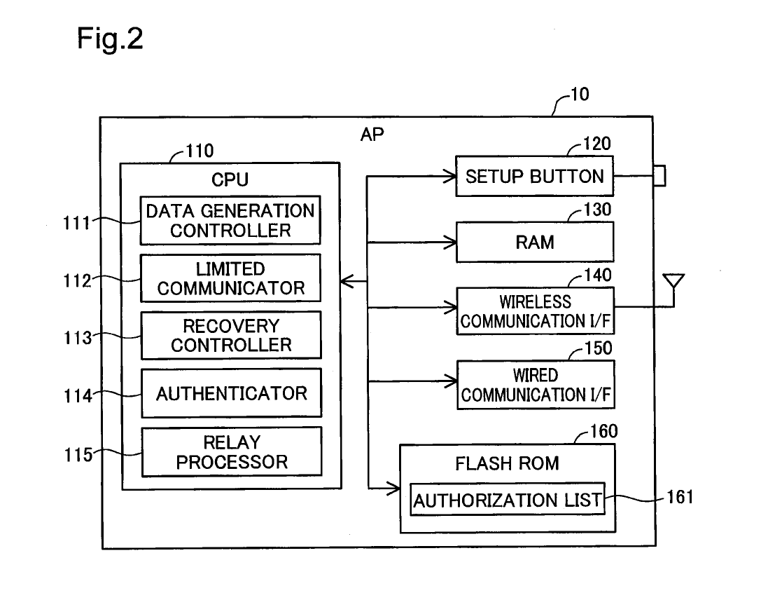

FIG. 2 is a diagram illustrating the schematic configuration of the AP 10. The AP 10 includes a CPU 110, a setup button 120, a RAM 130, a wireless communication interface (I/F) 140, a wired communication interface (I/F) 150 and a flash ROM 160. The respective elements of the AP 10 are interconnected by a bus.

The CPU 110 loads and executes computer programs, which are stored in the flash ROM 160, on the RAM 130 to control the AP 10. The CPU 110 serves as a data generation controller 111, a limited communicator 112, a recovery controller 113, an authenticator 114 and a relay processor 115.

The data generation controller 111 serves as the control entity of the restoration data generation process. The limited communicator 112 establishes temporary wireless communication used in the recovery process. The recovery controller 113 serves as the control entity of the recovery process. The authenticator 114 authenticates the client device in the recovery process. The relay processor 115 performs a relay process of forwarding each received packet according to its destination.

The setup button 120 is a momentary switch (self return switch) provided on the casing of the AP 10. The recovery process is triggered in the AP 10 by detection of the operation of the setup button 120. A switch other than the momentary switch may be employed for the setup button 120. A switch that does not keep its state is, however, preferably used for the setup button 120.

The wireless communication interface 140 includes a transmitting/receiving circuit and has the function of demodulating radio waves received via an antenna and generating data and the function of generating radio waves, which are to be transmitted via the antenna, and modulating the radio waves. The wired communication interface 150 is connected with a line on the Internet INT side, while being connected with a device in the LAN (for example, NAS 20) by a cable. The wired communication interface 150 includes a PHY/MAC controller and serves to shape the waveform of a received signal and extract an MAC frame from the received signal.

The flash ROM 160 includes an authorization list 161. The authorization list 161 stores information for authentication of client devices by the authenticator 114. The information for authentication of client devices may be described in any format, for example, the combination of a user ID and a password or an identifier uniquely assigned to each client device.

A-3. Schematic Configuration of Client Device

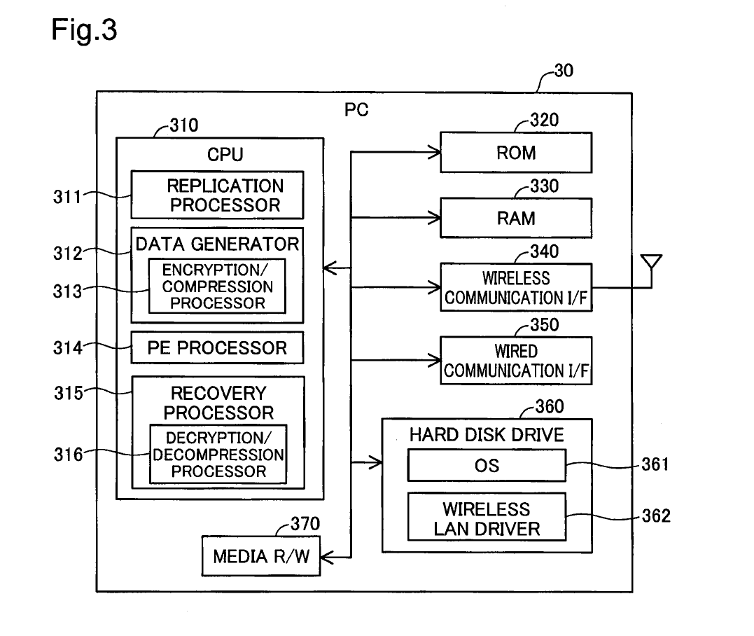

FIG. 3 is a diagram illustrating the schematic configuration of the PC 30. The PC 30 as the client device includes a CPU 310, a ROM 320, a RAM 330, a wireless communication interface (I/F) 340, a wired communication interface (I/F) 350, a hard disk drive 360 and a media reader writer (R/W) 370. The respective elements of the PC 30 are interconnected by a bus.

The CPU 310 loads and executes computer programs, which are stored in the hard disk drive 360, on the RAM 330 to control the PC 30. The CPU 310 serves as a replication processor 311, a data generator 311, an encryption/compression processor 313, a PE (Preinstallation Environment) processor 314, a recovery processor 315 and a decryption/decompression processor 316.

The replication processor 311 replicates information stored in the hard disk drive 360. The data generator 312 uses the information replicated by the replication processor 311 to generate restoration data and sends the generated restoration data to the AP 10. The encryption/compression processor 313 encrypts and compresses data. The replication processor 311, the data generator 312 and the encryption/compression processor 313 may be provided in advance in the PC 30 or may be newly provided in the PC 30 at a step in the restoration data generation process described later. According to this embodiment, the latter configuration is described as an example. The replication processor 311 is equivalent to the “replication function” according to “another aspect of the disclosure”. The data generator 312 is equivalent to the “transmission function” according to “another aspect of the disclosure”. The encryption/compression processor 313 is equivalent to the “encryption function” and the “compression function” according to “another aspect of the disclosure”.

In the state that an operating system or OS 361 is not started in the PC 30, the PE processor 314 operates in place of the OS 361 to provide the user with a GUI (Graphical User Interface) environment as the minimum requirement for the operations of the respective elements of the PC 30. The PE processor 314 is provided in the PC 30 at a step in the recovery process described later. The GUI environment provided by the PE processor 314 is a transient operating environment for the recovery process and is equivalent to the “temporary operating environment” according to “another aspect of the disclosure”. In the description hereafter, the temporary operating environment is also called “preinstalled environment”.

The recovery processor 315 uses the restoration data to recover the system of the PC 30. The decryption/decompression processor 316 decompresses the compressed data and decrypts the encrypted data. The recovery processor 315 and the decryption/decompression processor 316 are provided in the PC 30 at a step in the recovery process described later. The recovery processor 315 is equivalent to the “request function”, the “receiving function” and the “recovery function” according to “another aspect of the disclosure”. The decryption/decompression processor 316 is equivalent to the “decompression function” and the “decryption function” according to “another aspect of the disclosure”.

The wireless communication interface 340 includes a transmitting/receiving circuit and has the function of demodulating radio waves received via an antenna and generating data and the function of generating radio waves, which are to be transmitted via the antenna, and modulating the radio waves. The wired communication interface 350 is connected with a device as the other end of communication by a cable. The wired communication interface 350 includes a PHY/MAC controller and serves to shape the waveform of a received signal and extract an MAC frame from the received signal.

The hard disk drive 360 includes the OS 361 and a wireless LAN driver 362. The OS 361 provides the user with a GUI environment for operating the respective elements of the PC 30. The wireless LAN driver 362 controls the operations of the wireless communication interface 340 to enable the PC 30 to establish wireless connection with the AP 10. The wireless LAN driver 362 is equivalent to the “device driver for wireless communication” according to “another aspect of the disclosure”.

The media R/W 370 reads and writes data from and into an auxiliary storage device externally attached to the PC 30. The auxiliary storage device may be, for example, a flash memory such as a USB (Universal Serial Bus) memory or a memory card, an optical disc such as a CD (Compact Disc), a DVD (Digital Versatile Disc) or BD (Blue-ray Disc) or a magneto optical disc such as MO (Magnetic Optical) disc. Otherwise the auxiliary storage device may be a hard disk drive or an SSD (Solid State Drive) built in via an E-SATA (External Serial ATA) interface or an SATA (Serial Advanced Technology Attachment) interface.

The PC 30 is described herein only as an example of the client device, and the PC40 has the similar configuration and functions to those of the PC 30.

A-4. Restoration Data Generation Process

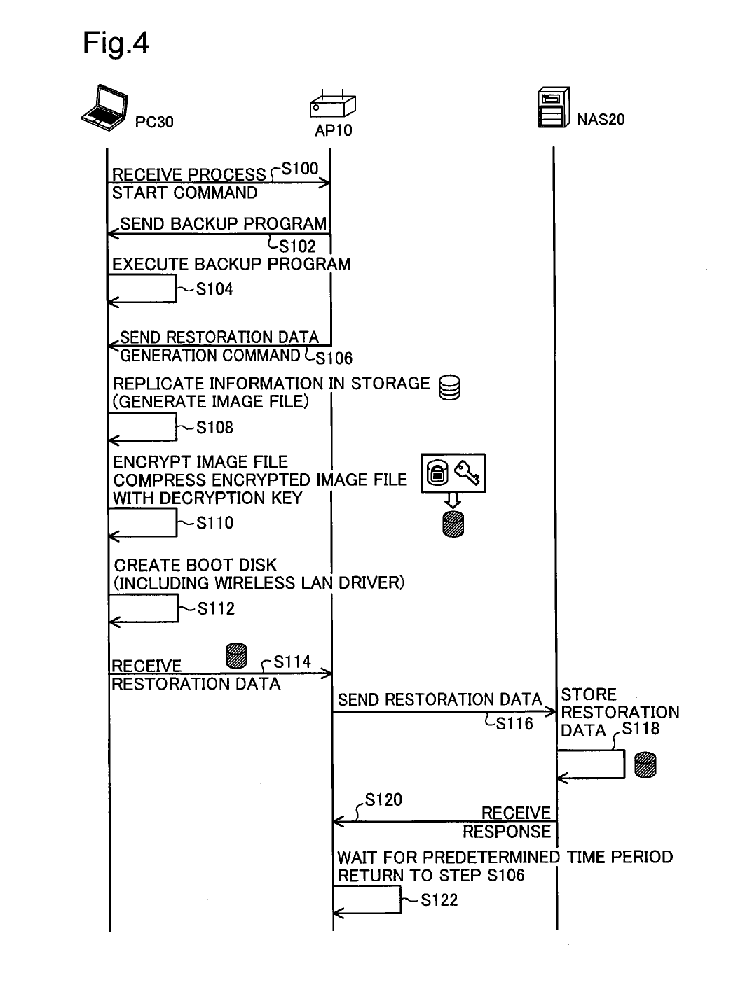

FIG. 4 is a sequence diagram showing a procedure of the restoration data generation process. The restoration data generation process is performed to generate the restoration data used for recovery of the client device and store the generated restoration data externally (in the NAS 20 connected with the AP 10 in the illustrated example). The restoration data generation process is triggered when the AP 10 receives a process start command from the PC 30 (step S100). The PC 30 may provide the start command of the restoration data generation process (step S100) in any of various forms. For example, the start command may be given in a setup window of the AP 10 provided by a WEB (World Wide Web) or may be given by an operation of a specific button provided on the AP 10. The following description regards the PC 30 as an example of the client device. The AP 10, however, actually performs the following series of processing for all the client devices connected with the AP 10, for example, the PC 40.

The data generation controller 111 of the AP 10 sends a backup program to the PC 30 (step S102). The backup program is a file that is installed in the PC 30 and is executed by the CPU 310 to serve as the replication processor 311, the data generator 312 and the encryption/compression processor 313 shown in FIG. 3. After receiving the backup program, the CPU 310 of the PC 30 executes the backup program (step S104). The processing of step S104 enables the respective functional blocks, i.e., the replication processor 311, the data generator 312 and the encryption/compression processor 313, in the PC 30. This configuration enables generation of the restoration data even when no computer program used for generating the restoration data has been installed in advance in the PC 30.

After elapse of a predetermined time period since transmission of the backup program, the data generation controller 111 of the AP 10 sends a restoration data generation command to the PC 30 (step S106). When receiving the restoration data generation command, the replication processor 311 of the PC 30 replicates the information stored in the hard disk drive 360 into a free space of the hard disk drive 360 (step S108). More specifically, the replication processor 311 generates an image file by replicating the contents of the hard disk drive 360. In the configuration of the hard disk drive 360 that is separated into a plurality of drives, an image file may be generated for each drive.

After generation of the image file, the data generator 312 sends instructions to the encryption/compression processor 313 to encrypt the image file and compress the encrypted data in combination with a decryption key used for decryption of the encrypted data (step S110). In response to the instructions, the encryption/compression processor 313 encrypts the image file (i.e., replicated data of the hard disk drive 360) by a predetermined encryption method. The encryption/compression processor 313 then compresses the encrypted data in combination with the decryption key used for decryption of the encrypted data, so as to generate the restoration data. When the encryption/compression processor 313 employs the secret key cryptosystem (common key cryptosystem) for encryption, the decryption key is the same as the key used for encryption. When the encryption/compression processor 313 employs the public key cryptosystem, on the other hand, the decryption key is different from the key used for encryption but is an exclusive key for decryption.

After generation of the restoration data, the data generator 312 creates a boot disk including the wireless LAN driver 362 (step S112). The boot disk is an auxiliary storage device (medium), which a file that is installed in the PC 30 and is executed by the CPU 310 to serve as the PE processor 314 shown in FIG. 3 is written in. More specifically, the data generator 312 writes a module for enabling the functions of the PE processor 314 and the wireless LAN driver 362 currently used by the PC 30 into a medium inserted in the media R/W 370.

After creation of the boot disk, the data generator 312 sends the restoration data generated at step S110 to the AP 10 (step S114).

The data generation controller 111 of the AP 10 receives the restoration data and stores the received restoration data in a specified storage (steps S116 and S118). According to this embodiment, the data generation controller 111 sends the received restoration data to the NAS 20 connected with the AP 10 (step S116) and stores the restoration data in a hard disk drive of the NAS 20 (step S118). At steps S116 and S118, it is preferable that the data generation controller 111 correlates information for identifying to which client device the restoration data belongs (for example, user name or MAC address) to, for example, the file name, the file header or the property of the restoration data. Such correlation enables differentiation of the restoration data even when the restoration data for a plurality of client devices (for example, the PC 30 and the PC 40) are stored in the NAS 20.

After receiving a response indicating successful storage of the restoration data from the NAS 20 (step S120), the data generation controller 111 of the AP 10 waits for a predetermined time period and then returns the processing to step S106 (step S122). The predetermined time period at step S122 may be determined arbitrarily. When the predetermined time period is, for example, 24 hours, the AP 10 obtains the restoration data from the PC 30 and stores the obtained restoration data into the NAS 20 every 24 hours. This accordingly enables the network system 1000 to store the backup of each client device every 24 hours. A second or subsequent cycle of the restoration data generation process may be triggered when the AP 10 receives a next instruction from the PC 30. This means that the predetermined time period at step S122 may be a time period until the AP 10 receives a next instruction from the PC 30. The processing of step S112 may be omitted in the second or the subsequent cycle of the restoration data generation process (FIG. 4).

The processing of step S102 is equivalent to the “step of the wireless connection device sending the client device a computer program for replicating the information in the memory of the client device, generating the restoration data and sending the generated restoration data to the wireless connection device” according to “another aspect of the disclosure”. Similarly, the processing of step S108 is equivalent to the “step of the client device replicating information in a memory of the client device” according to “another aspect of the disclosure”. The processing of steps S110 and S114 is equivalent to the “step of the client device using the replicated information in the memory to generate the restoration data and sending the generated restoration data to the wireless connection device” according to “another aspect of the disclosure”. The processing of steps S116 and S118 is equivalent to the “step of the wireless connection device storing the received restoration data into the specified storage” according to “another aspect of the disclosure”.

As described above, in the restoration data generation process according to this embodiment, prior to the series of processing (recovery process) for the system recovery of the PC 30 (client device), the replication processor 311 and the data generator 312 of the PC 30 generate the restoration data from the replicated information in the hard disk drive 360 (memory) (step S110 in FIG. 4) and sends the generated restoration data to the AP 10 (wireless connection device) (step S114 in FIG. 4). The AP 10 then stores the received restoration data into the NAS 20 (specified storage) (steps S116 and S118 in FIG. 4). This configuration enables the restoration data for the system recovery of the PC 30 to be saved in advance in a device other than the PC 30.

Additionally, in the restoration data generation process described above, the data generation controller 111 of the AP 10 causes the trigger to automatically generate the restoration data (step S122 in FIG. 4) without needing the user of the PC 30 to spontaneously generate the restoration data. This configuration enhances the user's convenience. The restoration data generation process generates the restoration data at predetermined time intervals, thus reducing the possibility of “forgetting to make backups”, which is the problem of the conventional spontaneous backup system.

Furthermore, in the restoration data generation process described above, the data generator 312 and the encryption/compression processor 313 of the PC 30 encrypt the replicated information in the hard disk drive 360 and compress the encrypted data and the decryption key to generate the restoration data (step S110 in FIG. 4). This configuration enhances the security of the restoration data and reduces the storage capacity used for storing the restoration data.

The storage location of the restoration data at steps S116 and S118 according to this embodiment is only illustrative and may be changed in any of various ways. For example, the data generation controller 111 may store the received restoration data into the flash ROM 160 of the AP 10 or may store the received restoration data into an auxiliary storage device (for example, USB memory, memory card or hard disk) connected with the AP 10. The “specified storage” in which the AP 10 stores the restoration data may thus be provided in at least either the auxiliary storage device of the AP 10 or the storage device connected via a network to the AP 10 (the NAS20 according to this embodiment). The auxiliary storage device of the AP 10 includes both an auxiliary storage device built in the AP 10 and an auxiliary storage device connected to the AP 10 via an interface such as USB or SCSI (Small Computer System Interface). Providing the specified storage in the auxiliary storage device of the AP 10 allows omission of the NAS 20 and thereby enables the simple configuration of the network system 1000 including only the client device (the PC 30 according to this embodiment) and the AP 10. Providing the specified storage in the NAS 20, on the other hand, allows for the larger storage capacity.

A-5. Recovery Process

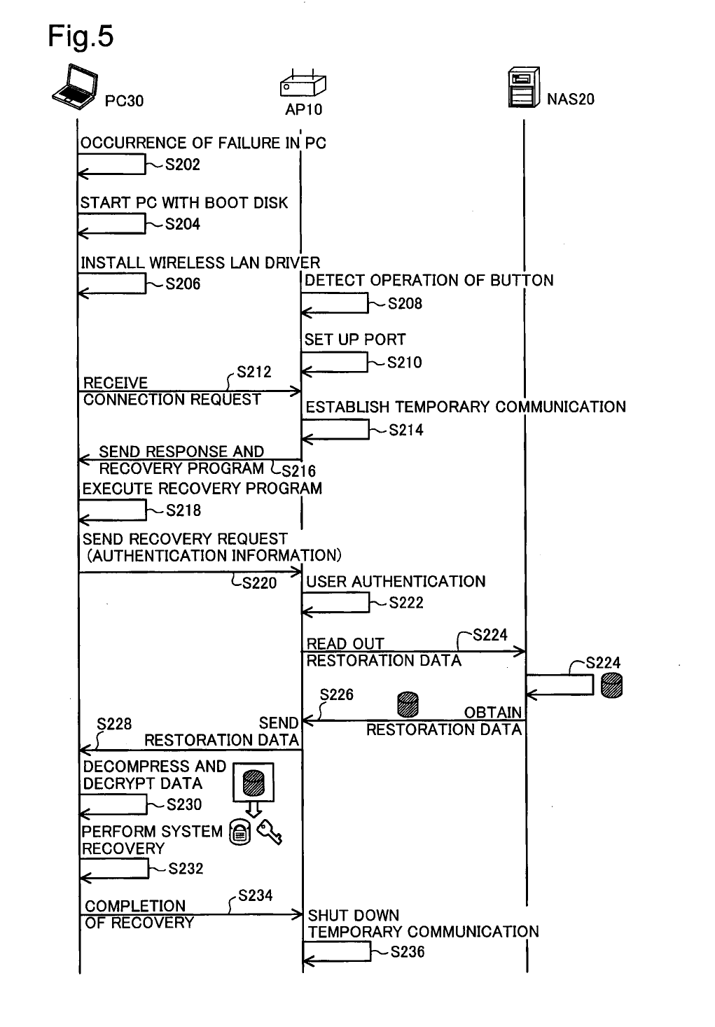

FIG. 5 is a sequence diagram showing a procedure of the recovery process. The recovery process is performed on the occurrence of a failure in the client device to use the restoration data and restore the operating environment of the failed client device to the environment prior to the occurrence of the failure (recover the system of the client device). The recovery process starts after the occurrence of a failure in the client device. The recovery process in the AP 10 is triggered when the AP 10 detects an operation of the setup button 120. The following description regards the PC 30 as an example of the client device. The AP 10, however, actually performs the following series of processing for all the client devices connected with the AP 10, for example, the PC 40.

After the occurrence of some failure in the PC 30, for example, failed start or malfunction of the PC 30 (step S202), the user of the PC 30 uses the boot disk to start the PC 30 (step S204). The boot disk used at step S204 is the boot disk created at step S122 in the restoration data generation process (FIG. 4). Installation of a module included in the boot disk in the PC 30 and execution of the module by the CPU 310 causes the PE processor 314 to be provided in the PC 30. Similarly installation of the wireless LAN driver 362 included in the boot disk in the PC 30 and execution of the wireless LAN driver 362 by the CPU 310 causes the wireless LAN driver 362 used in the PC 30 before the occurrence of the failure to be provided in the PC 30 (step S206). The user of the PC 30 subsequently operates the setup button 120 of the AP 10.

The AP 10 detects the operation of the setup button 120 (step S208) and sets up a port to establish temporary wireless communication with the PC 30 (step S210). More specifically, the limited communicator 112 of the AP 10 sets the SSID of a certain port as valid, sets the communication configuration to “no encryption” and changes the set value of the SSID to a value representing the temporary communication (for example, “!ABC”). The limited communicator 112 of the AP 10 sends a beacon including the changed SSID to the PC 30. The PC 30 is accordingly notified of the changed SSID. The processing of step S210 thus enables the PC 30 even without any special specification to be informed of the presence of the AP 10 with the SSID “!ABC”.

A wireless network connection screen is displayed on the display of the PC 30 receiving the beacon. The wireless network connection screen includes a list of information on at least one AP, from which the PC 30 receives the beacon, and a connection button to make connection with an AP selected in the list. The wireless network connection screen is provided by the PE processor 314. The user of the PC 30 manually selects an AP with the SSID “!ABC” (i.e., AP 10) in the list of the wireless network connection screen and operates the connection button. In response to the user's operation of the connection button, the wireless LAN driver 362 sends a connection request with specification of the selected SSID “!ABC” to the AP 10 (step S212). According to another embodiment, display of the wireless network connection screen on the PC 30, selection of an AP in the list and operation of the connection button may be performed automatically by a program.

When receiving the connection request from the PC 30, the limited communicator 112 of the AP 10 establishes temporary wireless communication with the PC 30 for the purpose of system recovery, based on the communication configuration of non-encryption set for the port identified by the SSID “!ABC” (step S214).

After establishment of the temporary wireless communication, the limited communicator 112 sends a recovery program together with a response indicating establishing of wireless communication to the PC 30 (step S216). The recovery program is a file that is installed in the PC 30 and is executed by the CPU 310 to serve as the recovery processor 315 and the decryption/decompression processor 316 shown in FIG. 3. After receiving the recovery program, the CPU 310 of the PC 30 executes the recovery program (step S218). The processing of step S218 enables the respective functional blocks, i.e., the recovery processor 315 and the decryption/decompression processor 316, in the PC 30. This configuration enables the system recovery of the PC 30 even without any specific computer program for the system recovery.

After execution of the recovery program, the recovery processor 315 of the PC 30 sends a recovery request and authentication information to the AP 10 (step S220). The authentication information herein means information used to verify that the user of the PC 30 is an authorized user. The authentication information may be, for example, a user name and a password. After receiving the recovery request, the authenticator 114 of the AP 10 uses the received authentication information to verify the legitimacy of the user of the PC 30 (user authentication) (step S222). For example, it is assumed that the user name and the password are used as the authentication information. In this case, when the combination of the user name and the password is present in the authorization list 161 in the flash ROM 160, the authenticator 114 determines successful authentication (authorized). When the combination of the user name and the password is not present in the authorization list 161, on the other hand, the authenticator 114 determines failed authentication (unauthorized). On determination of failed authentication, the authenticator 114 notifies the PC 30 of the failed authentication and requests the PC 30 to send the authentication information again (i.e., returns the processing to step S220).

On determination of successful authentication, on the other hand, the recovery controller 113 reads out the restoration data for the PC 30 from the specified storage (steps S224 and S226). More specifically, the recovery controller 113 reads out the restoration data correlated to, for example, the user name or the MAC address of the PC 30 from the hard disk drive of the NAS 20. The recovery controller 113 of the AP 10 subsequently sends the read-out restoration data to the PC 30 (step S228).

After receiving the restoration data, the recovery processor 315 of the PC 30 causes the decryption/decompression processor 316 to decompress and decrypt the received restoration data (step S230). The decryption/decompression processor 316 decompresses the restoration data according to the compression method of the restoration data. The decryption/decompression processor 316 then decrypts the encrypted data included in the decompressed restoration data by using the decryption key included in the decompressed restoration data. The recovery processor 315 accordingly obtains the image file of the hard disk drive 360 before the occurrence of the failure in the PC 30.

The recovery processor 315 performs the recovery using the image file (decrypted data) obtained at step S230 (step S232). More specifically, the recovery processor 315 replicates the image file obtained at step S230 in the hard disk drive 360. On successful replication, the recovery processor 315 sends a notification indicating completion of the recovery to the AP 10 (step S234). After receiving the notification indicating completion of the recovery, the limited communicator 112 of the AP 10 shuts down the temporary wireless communication (wireless communication with the SSID “!ABC”) (step S236) and terminates the recovery process.

The processing of step S206 is equivalent to the “step of the client device setting up a device driver for wireless communication in a tentative operating environment, which is a transient operating environment of the client device for performing system recovery” according to “another aspect of the disclosure”. Similarly the processing of steps S212 and S214 is equivalent to the “step of the wireless connection device establishing wireless communication with the client device” according to “another aspect of the disclosure”. The processing of steps S224 and S226 is equivalent to the “step of the wireless connection device obtaining restoration data, which is stored in advance in a specified storage and is used for the system recovery of the client device” according to “another aspect of the disclosure”. The processing of step S228 is equivalent to the “step of the wireless connection device sending the obtained restoration data via the wireless communication to the client device” according to “another aspect of the disclosure”. The processing of steps S230 and S232 is equivalent to the “step of the client device performing the system recovery using the received restoration data” according to “another aspect of the disclosure”. The processing of step S234 is equivalent to the “step of the client device sending a notification indicating completion of the system recovery to the wireless connection device” according to “another aspect of the disclosure”. The processing of step S236 is equivalent to the “step of the wireless connection device receiving the notification indicating completion of the system recovery and subsequently shutting down the wireless communication” according to “another aspect of the disclosure”.

As described above, in the recovery process according to this embodiment, after the occurrence of a failure in the PC 30 (client device), the PC 30 sets up the wireless LAN driver 362 (device driver for wireless communication) in the temporary operating environment (preinstalled environment) provided by the PE processor 314 (step S206 in FIG. 5). The AP 10 (wireless connection device) establishes non-limited and temporary wireless communication (wireless communication with the SSID “!ABC”) with the PC 30 (step S214 in FIG. 5). The PC 30 then performs system recovery using the restoration data received from the AP 10 via the temporary wireless communication (steps S216 and S218 in FIG. 5). The network system 1000 accordingly enables the easy system recovery of the PC 30 or the PC 40 without providing any separate server. Additionally, the network system 1000 enables the system recovery of the PC 30 or the PC 40 via the wireless communication.

Furthermore, in the recovery process described above, the AP 10 receives the notification indicating completion of the system recovery from the PC 30 and subsequently shuts down the temporary wireless communication (steps S234 and S236 in FIG. 5). This prevents the temporary wireless communication of the insufficient security from being maintained after completion of the recovery process. This results in enhancing the network security of the network system 1000. The processing of steps S234 and S236 may be omitted as needed basis.

Moreover, at steps S222 and S224 in the recovery process described above, the AP 10 verifies whether the PC 30 is authenticated, obtains the restoration data in the case of successful authentication, and sends the obtained restoration data to the PC 30. This configuration prevents the restoration data of the PC 30 from being mistakenly sent to an unauthorized computer. This results in enhancing the network security of the network system 1000. The processing of step S222 may be omitted as needed basis.

In the recovery process described above, the communication established between the AP 10 and the PC 30 is the wireless communication based on the predetermined communication configuration of no encryption (wireless communication with the SSID “!ABC”) (steps S210 to S214 in FIG. 5). This configuration enables the system recovery of the PC 30 by using the wireless communication of the low security level that is readily accessible from the PC 30. More specifically, the communication established between the AP 10 and the PC 30 in the recovery process is wireless communication without encryption and accordingly does not need the preliminary transmission for encrypted communication between the AP 10 and the PC 30 or the encryption in the PC 30. This configuration reduces the processing load on the PC 30 in the recovery process. This configuration also reduces the risk that the recovery process takes time or the recovery process is failed, due to a failure in preliminary transmission for encryption between the PC 30 and the AP 10, for example, failed exchange of an encryption key. Compared with the configuration that a module of the PE processor having the function of encrypted communication is stored in a boot disk at step S112 in FIG. 4, this configuration reduces the file size of the module of the PE processor stored in the boot disk.

### B. Second Embodiment

A second embodiment of the disclosure describes the configuration that omits the restoration data generation process. Only the configuration and the operations different from those of the first embodiment are described below.

B-1. Schematic System Configuration

The configuration of a network system according to the second embodiment is substantially similar to that of the first embodiment shown in FIG. 1. The configurations of the AP 10 and the PC 30 and their processing flows are, however, different from those of the first embodiment. The details will be described later.

B-2. Schematic Configuration of Wireless Network Device

The configuration of an AP 10 according to the second embodiment is substantially similar to that of the first embodiment shown in FIG. 2. The AP 10 of the second embodiment, however, does not have the data generation controller 111. The other configuration of the AP 10 according to the second embodiment is the same as that of the first embodiment shown in FIG. 2.

B-3. Schematic Configuration of Client Device

The configuration of the PC 30 according to the second embodiment is substantially similar to that of the first embodiment shown in FIG. 3. The PC 30 of the second embodiment, however, does not have the replication processor 311, the data generator 312 or the encryption/compression processor 313. The other configuration of the PC 30 according to the second embodiment is the same as that of the first embodiment shown in FIG. 3.

B-4. Restoration Data Generation Process

The second embodiment does not perform the restoration data generation process. According to the second embodiment, the restoration data is prepared in advance by the user of the PC 30 and is stored in a specified storage (e.g., hard disk drive of the NAS 20).

B-5. Recovery Process

The procedure of the recovery process according to the second embodiment is substantially similar to that of the first embodiment shown in FIG. 5.

As described above, in the recovery process according to the second embodiment, after the occurrence of a failure in the PC 30 (client device), the PC 30 sets up the wireless LAN driver 362 (device driver for wireless communication) in the temporary operating environment (preinstalled environment) provided by the PE processor 314 (step S206 in FIG. 5). The AP 10 (wireless connection device) establishes non-limited and temporary wireless communication (wireless communication with the SSID “!ABC”) with the PC 30. The PC 30 then performs system recovery using the restoration data received from the AP 10 via the temporary wireless communication. The recovery process according to the second embodiment accordingly has the similar advantageous effects to those of the recovery process according to the first embodiment.

### C. Third Embodiment

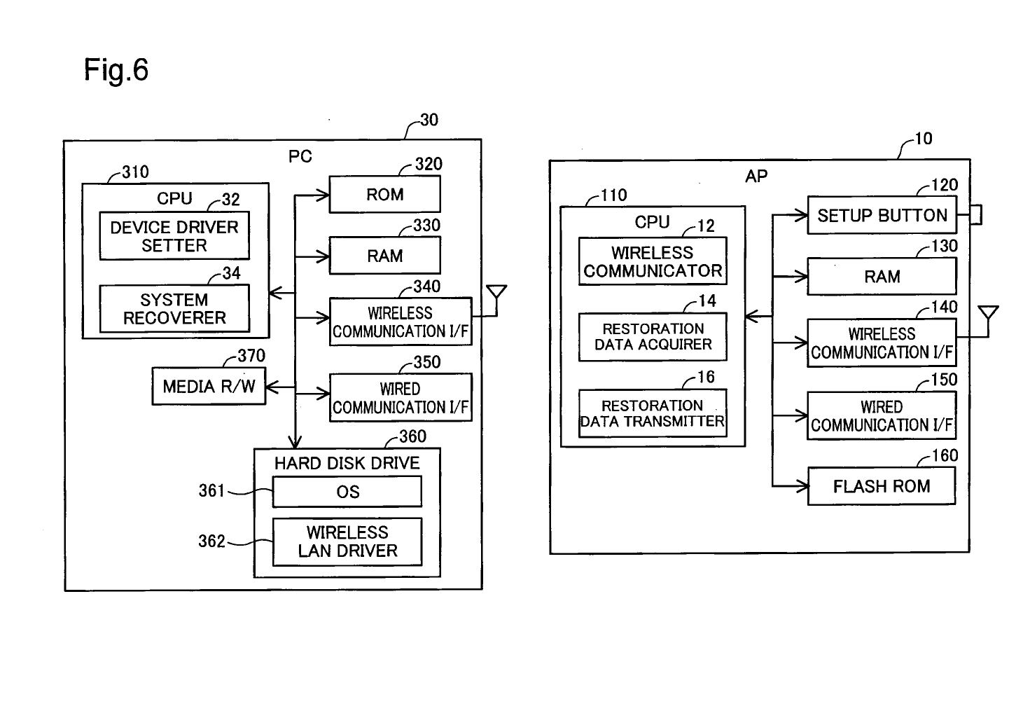

FIG. 6 is a diagram illustrating the schematic configuration of a client device 30 and a wireless connection device 10 according to a third embodiment. The third embodiment employs the following configuration to enable system recovery of the client device 30 connected with the wireless connection device 10.

The client device 30 includes a device driver setter 32 configured to set up a device driver for wireless communication in a temporary operating environment that is the transient operating environment of the client device 30 for system recovery. The wireless connection device 10 includes a wireless communicator 12 configured to establish wireless communication with the client device 30 for system recovery. The wireless connection device 10 also includes a restoration data acquirer 14 configured to obtain restoration data that is stored in advance in a specified storage and is used for system recovery of the client device 30. The wireless connection device 10 also includes a restoration data transmitter 16 configured to send the obtained restoration data to the client device 30 via wireless communication. The client device 30 further includes a system recoverer 34 configured to perform system recovery using the received restoration data.

### D. Modifications

In any of the embodiments described above, part of the hardware configuration may be replaced by software configuration, while part of the software configuration may be replaced by hardware configuration. Examples of other possible modifications are described below.

Modification 1:

The above embodiment (FIG. 2) describes the configuration of the access point (AP) used as the wireless connection device. The configuration of the wireless connection device according to the above embodiment is, however, only illustrative, and any of other configurations may be adopted. For example, part of the elements may be omitted, different elements may be added, or part of the elements may be changed or modified.

Any of various devices that are capable of making wireless connection may be employed for the wireless connection device. The wireless connection device may be, for example, a network communication device such as a router, a hub or a modem, a storage device such as an NAS (Network Attached Storage) or an image input-output device such as a digital camera, a printer, a network display or a scanner.

According to the above embodiment, a momentary switch is employed for the setup button provided on the AP. Any of various other configurations may, however, be employed for the setup button, as long as the configuration is provided as input means to give a start instruction for the recovery process to the AP in a form that is directly accessible by the user, in a form that enables near field communication from the neighbor of the AP or in a form that takes an image of an information code provided by the AP with a built-in camera of the client. For example, in the AP equipped with a display, GUI may be employed for the setup button. In another example, infrared communication or a contact or non-contact IC card may be employed for the setup button. An information code such as QR code (registered trademark), barcode or hologram may be employed for the setup button. Any of these configurations prevents any malicious third person from giving a start instruction for the recovery process to the AP against the user's intention and thereby prevents leakage of the restoration data. In order to prevent an unauthorized access from any malicious third person, it is preferable to minimize the coverage where a start instruction for the recovery process is given to the AP. For example, the coverage may be a range of within 10 meters from the AP, is preferably a range of within 5 meters from the AP and is more preferably a range of within 1 meter from the AP. The coverage is most preferably a range of within 0 meter from the AP, which indicates the configuration that gives a start instruction only by the user's direct touch.

According to the above embodiment, the authorization list is stored in the flash ROM of the AP. This list may, however, be stored in a storage medium other than the flash ROM. For example, the AP may be provided with a USB (Universal Serial Bus) interface, and the list may be stored in a detachable storage medium such as a USB memory or a USB hard disk drive.

Modification 2

The above embodiment (FIG. 3) describes the configuration of the personal computer (PC) used as the client. The configuration of the client according to the above embodiment is, however, only illustrative, and any of other configuration may be adopted.

Any of various devices other than the PC may be employed for the client. The client may be, for example, a mobile phone such as smartphone, an Ethernet converter (Ethernet is registered trademark), a PDA (Personal Digital Assistant), a game machine, an audio player, a printer, or a TV set.

For example, among the elements of the PC shown in FIG. 3, part of the elements may be omitted, different elements may be added, or part of the elements may be changed or modified.

Modification 3

The above embodiment describes the procedure of the restoration data generation process with reference to FIG. 4. This procedure of the restoration data generation process is, however, only illustrative and may be modified and changed in any of various ways. For example, part of the steps may be omitted, different steps may be added, or the sequence of the steps may be changed.

According to the above embodiment, the data generation controller 111 of the AP 10 sends the backup program to the PC 30 (step S102). The PC 30 may, however, obtain the backup program by another method. For example, the backup program may be obtained via a specified medium which the PC 30 can read. In the configuration of the PC equipped with the replication processor, the data generator and the encryption/compression processor, the processing of steps S102 and S104 in the restoration data generation process shown in FIG. 4 may be omitted.

According to the above embodiment, the replication processor generates an image file by replicating the contents of the hard disk drive at step S108. The target of the replication processor to generate the image file may, however, be changed and modified in any of various ways. For example, in a second or subsequent cycle of the restoration data generation process, the replication processor may generate an image file with respect to only the difference from the image file generated in a first cycle and stored in the hard disk drive. This configuration reduces the volume of the replicated data and thereby enables a greater amount of the replicated data to be stored in the NAS or in the AP.

According to the above embodiment, the encryption/compression processor 313 encrypts the replicated data of the hard disk drive 360 by a predetermined encryption method (step S110). The restoration data may, however, be stored in a non-encrypted state.

According to the above embodiment, the encryption/compression processor 313 compresses the encrypted data in combination with the decryption key used for decrypting the encrypted data (step S110). The restoration data may, however, be compressed separately without the decryption key. The restoration data may alternatively be stored in a non-compressed state.

Modification 4

The above embodiment describes the procedure of the recovery process with reference to FIG. 5. This procedure of the recovery process is, however, only illustrative and may be modified and changed in any of various ways. For example, part of the steps may be omitted, different steps may be added, or the sequence of the steps may be changed.

According to the above embodiment, the limited communicator of the AP sends the recovery program functioning as the recovery processor and the decryption/decompression processor shown in FIG. 3 (step S216). The PC 30 may, however, obtain the recovery program by another method. For example, the boot disk provided as the medium for starting may be configured to store a computer program for system recovery and may be used to enable the computer program for system recovery in the client device. When the PE processor provided by the boot disk includes the functions of the recovery processor and the decryption/decompression processor, the transmission of the recovery program at step S216 may be omitted. In this application, the computer program for system recovery may be stored in a medium other than the medium for starting, which the PC 30 can read. After the start of the client device, the medium may be used to enable the computer program for system recovery in the client device.

According to the above embodiment, the authenticator uses the user name and the password to verify the legitimacy of the user of the PC 30 (user authentication) at steps S220 and S222. The method using the user name and the password is, however, only illustrative, and the authenticator may employ any of various other methods for user authentication. For example, the authenticator may use a one-time password or a PIN code of the AP to perform the user authentication.

According to the above embodiment, on determination of failed authentication at step S222, the authenticator requests the client device to send the authentication information again. According to another embodiment, however, on determination of failed authentication at step S222, the authenticator may shut down the temporary wireless communication and terminate the recovery process, instead of requesting the retransmission. This latter configuration prevents a brute-force attack from any illegal third person, thus preferably enhancing the security.

The AP 10 may be configured to read out the restoration data without user authentication. This configuration reduces the load on the PC 30 in the recovery process, compared with the configuration that the PC 30 sends the authentication information with a recovery request.

According to the above embodiment, the PC 30 is started by the boot disk provided as the auxiliary storage device (medium) that is created in advance via the media R/W 370 and is read via the media R/W 370 (step S204 in FIG. 5). The PC 30 may, however, be started by another method. For example, the PC 30 may be configured to have a specific area in the hard disk drive 360 that has the function of the boot disk as the medium for starting, and this specific area may be used to provide and set up the function of the device driver for wireless communication.

According to the above embodiment, the installation and the setup of the wireless LAN driver 362 are performed by using the boot disk provided as the auxiliary storage device (medium) that is created in advance via the media R/W 370 and is read via the media R/W 370 (step S206 in FIG. 5). Another method may, however, be employed to set up the device driver for wireless communication. For example, the PC 30 may be configured to have a specific area in the hard disk drive 360 that has the function of the boot disk as the medium for starting and also has the function of the device driver. This specific area may be used to provide and set up the function of the device driver for wireless communication.

According to the above embodiment, the wireless LAN driver 362 is a wireless LAN driver used in the PC 30 before the occurrence of a failure. The device driver for wireless communication installed in the PC 30 in the recovery process may, however, be different from the wireless LAN driver used in the PC 30 before the occurrence of a failure. For example, the device driver for wireless communication installed in the PC 30 may be a device driver adjusted according to the PE processor 314 or a device driver exclusively used for the PE processor 314, which operates in place of the OS 361 and provides the user with the used minimum GUI environment.

According to the above embodiment, the AP 10 sets up the port with the communication configuration of “no encryption” (step S210) and establishes temporary wireless communication with the PC 30 for the recovery process (step S214). According to another embodiment, however, the AP 10 may establish wireless communication with encryption, as the wireless communication for the recovery process. This latter configuration enables the recovery process to be performed more safely.

It is, however, preferable that the wireless communication for the recovery process is either wireless communication with encryption of the less loading than the highest possible encryption allowable by the PC 30 as the client device or wireless communication without encryption. This configuration reduces the load on the client device in the recovery process.

According to the above embodiment, after receiving the notification indicating completion of the recovery, the limited communicator 112 of the PA 10 shuts down the wireless communication (step S236). The wireless communication for the recovery process may, however, be terminated at another timing. For example, wireless communication may be shut down when a predetermined time period has elapsed since establishment of the wireless communication.

Modification 5

The above embodiments describe the configurations of the network system. The configurations of the network system according to the above embodiments are, however, only illustrative and may be changed and modified in any of various ways. For example, part of the elements may be omitted, different elements may be added, or part of the elements may be changed or modified.

For example, the restoration data may be stored on a cloud server provided by cloud computing, instead of the NAS. In this application, the procedure of the restoration data generation process (FIG. 4) should be substituted as follows:
After execution of the backup program at step S104, the replication processor of the PC receives from the user the specification of a cloud server, in which the restoration data is to be stored. The replication processor then temporarily registers the identifier of the cloud server, the user name and the password in a storage medium such as a hard disk drive;
After generation of the restoration data at step S110, the data generator of the PC creates a boot disk including the wireless LAN driver, the identifier of the cloud server, the user name and the password;
At step S114, the data generator of the PC sends the restoration data generated at step S110, the identifier of the cloud server, the user name and the password to the AP;
At step S116, the data generation controller of the AP establishes connection with the cloud server identified by the identifier received at step S114 by using the user name and the password received at step S114 to store the restoration data into the connected cloud server;
At step S118, the cloud server stores the received restoration data in correlation to the user name used for establishing the connection, in a specified storage; and
At step S120, the cloud server sends a response indicating successful storage of the restoration data to the AP.

Similarly the recovery process (FIG. 5) should be substituted as follows:
At step S220, the recovery processor of the PC sends the identifier of the cloud server, the user name and the password, in addition to the recovery request and the authentication information to the AP; and
At step S224, the recovery controller of the AP establishes connection with the could server identified by the identifier received at step S220 by using the user name and the password received at step S220 to read out the restoration data for the PC from the cloud server.

This configuration enables the restoration data to be stored on the cloud server, instead of the NAS. This allows the easier system construction at the lower cost, compared with the configuration using the NAS.

Modification 6

The disclosure may provide any of the following aspects and configurations.

(1) According to a first aspect of the disclosure, there is provided a method of recovering of a client device connected with a wireless connection device. This method comprising: (a) setting up, by the client device, a device driver for wireless communication in a tentative operating environment, wherein the tentative operating environment is a transient operating environment of the client device for performing system recovery; (b) establishing, by the wireless connection device, wireless communication with the client device; (c) obtaining, by the wireless connection device, restoration data, wherein restoration data is stored in advance in a specified storage and is used for the system recovery of the client device; (d) sending, by the wireless connection device, the obtained restoration data to the client device; and (e) performing, by the client device, the system recovery based on the received restoration data. According to the method of this aspect, the client device sets up the device driver for wireless communication; the wireless connection device establishes wireless communication with the client device; and the client device performs system recovery based on the restoration data received via the wireless communication from the wireless connection device. The method of this aspect accordingly enables the easy system recovery of the client device without providing a separate server. The method of this aspect also enables the system recovery of the client device via wireless communication.

(2) In the method according to the above aspect, the setting up the device driver for wireless communication may use a storage medium for starting, wherein the storage medium for starting is used to start the client device and enables function of the device driver for wireless communication in the client device. This configuration can start the client device in a state that needs the system recovery and can set up the device driver for wireless communication in the client device.

(3) In the method according to this aspect, the storage medium for starting may store a computer program for the system recovery; the method may further include the enabling function of the computer program for the system recovery in the client device based on the storage medium for starting, before the system recovery; and the performing the system recovery may execute the computer program. This configuration enables the computer program for the system recovery in the client device in a state that needs the system recovery.

(4) The method according to this aspect may further include: (f) sending, by the client device, a notification indicating completion of the system recovery to the wireless connection device; and (g) receiving, by the wireless connection device, the notification indicating completion of the system recovery and subsequently shutting down the wireless communication. According to the method of this embodiment, the wireless connection device receives the notification indicating completion of the system recovery from the client device and then shuts down the temporary wireless communication. This configuration prevents the temporary wireless communication of the insufficient security from being maintained after completion of the system recovery. This accordingly enhances the network security.

(5) In the method according to this aspect, the step (c) may include: (c-2) obtaining, by the wireless connection device, authentication information from the client device; (c-3) performing, by the wireless connection device, authentication of the client device based on the obtained authentication information; and (c-4) obtaining, by the wireless connection device, the restoration data from the specified storage, in the case of successful authentication. According to the method of this embodiment, the wireless connection device obtains the restoration data in the case of successful authentication of the client device and sends the obtained restoration data to the client device. This configuration prevents the restoration data for the client device from being mistakenly sent to any unauthorized computer. This accordingly enhances the network security.

(6) The method according to this aspect may further include: after the establishment of the wireless communication but before the system recovery, sending, by the wireless connection device, a computer program for the system recovery via the wireless communication to the client device. This configuration enables the system recovery even without a computer program for the system recovery provided in advance in the client device.

(7) The method according to this aspect may further include: before the step (a), (A) replicating, by the client device, information in a memory of the client device; (B) using, by the client device, the replicated information in the memory to generate the restoration data and sending the generated restoration data to the wireless connection device; and (C) storing, by the wireless connection device, the received restoration data in the specified storage. According to the method of this embodiment, before the series of processing to perform the system recovery of the client device, the client device generates the restoration data based on the replicated information in the memory and sends the generated restoration data to the wireless connection device; and the wireless connection device stores the received restoration data in the specified storage. This configuration enables the restoration data for the client device to be saved in advance in a device other than the client device.

(8) In the method according to this aspect, the step (B) may include: (B-1) encrypting, by the client device, the replicated information in the memory; and (B-2) compressing encrypted data and a decryption key to generate the restoration data. According to the method of this embodiment, the client device encrypts the replicated information in the memory and compresses encrypted data and a decryption key to generate the restoration data. This configuration enhances the security of the restoration data and reduces the storage capacity used for storing the restoration data.

(9) The method according to this aspect may further include: before the step (a), (D) sending, by the wireless connection device, the client device a computer program for enabling the step (A) and the step (B). According to the method of this embodiment, before the series of processing to perform the system recovery of the client device, the wireless connection device sends a computer program executed by the client device to generate the restoration data to the client device. This configuration enables generation of the restoration data even without a computer program for generating the restoration data provided in advance in the client device.

(10) In the method according to this aspect, the specified storage may be provided in at least either an auxiliary storage device of the wireless connection device or a storage device connected via a network to the wireless connection device. According to the method of this embodiment, the specified storage, which the wireless connection device stores the restoration data in and obtains the restoration data from is provided in at least either the auxiliary storage device of the wireless connection device or the storage device connected via the network to the wireless connection device. Providing the specified storage in the auxiliary storage device of the wireless connection device enables the method of this embodiment to be performed by the simple configuration including only the client device and the wireless connection device. Providing the specified storage in the storage device connected via the network to the wireless connection device, on the other hand, allows for the larger storage capacity.

(11) In the method according to this aspect, the wireless communication may be either wireless communication with encryption of less loading than highest possible encryption allowable in the client device or wireless communication without encryption. This configuration reduces the load of wireless communication performed in the tentative operating environment, compared with the configuration of making wireless communication with highest possible encryption allowable in the client device prior to the state that needs the system recovery.

According to the method of this embodiment, the temporary wireless communication may be enabled without any specified encryption or with communication configuration of low encryption level. The method of this embodiment enables the system recovery of the client device based on the wireless communication that is easily accessible from the client device.

(12) According to another aspect of the disclosure, there is provided a wireless communication device. This wireless communication device includes: a limited communicator configured to establish wireless communication with a client device connected with the wireless connection device for performing system recovery of the client device; and a recovery controller configured to obtain restoration data, wherein restoration data is stored in advance in a specified storage and is used for the system recovery of the client device and to send the obtained restoration data via the wireless communication to the client device. The wireless connection device of this aspect enables the easy system recovery of the client device without providing a separate server. The wireless connection device of this aspect also enables the system recovery of the client device via wireless communication.

(13) According to yet another aspect of the disclosure, there is provided a computer program executed by a computer that is capable of establishing wireless communication with a wireless connection device. This computer program causes a computer to achieve: a replication function of replicating information in a memory of the computer; an encryption function of encrypting replicated data; a compression function of compressing encrypted data and a decryption key; and a transmission function of sending compressed data as restoration data to the wireless connection device. The computer program of this aspect provides the client device with the functions of replicating information in the memory of the computer, generating the encrypted and compressed restoration data and sending the generated restoration data to the wireless connection device.

(14) According to another aspect of the disclosure, there is provided a computer program executed by a computer that is capable of establishing wireless communication with a wireless connection device. This computer program causes a computer to achieve: a request function of requesting the wireless connection device to obtain restoration data; a receiving function of receiving the restoration data from the wireless connection device; a decompression function of decompressing the received restoration data; a decryption function of decrypting encrypted data included in the decompressed restoration data based on a decryption key included in the decompressed restoration data; and a recovery function of replicating decrypted data in a memory of the computer to perform system recovery. The computer program of this aspect provides the client device with the functions of obtaining the restoration data from the wireless connection device, decompresses and decrypts the obtained restoration data and performing system recovery based on the decrypted data.

All the plurality of elements included in each of the various aspects of the disclosure described above are not essential, but in order to solve part or all of the problems described above or in order to achieve part or all of the advantageous effects described herein, part of the plurality of elements may be changed or deleted, may be replaced with other additional elements or may be subjected to partial omission of their limitations. In order to solve part or all of the problems described above or in order to achieve part or all of the advantageous effects described herein, an independent aspect of the disclosure may be configured by combining part or all of the technical features incorporated in one of the various aspects of the disclosure described above with part or all of the technical features incorporated in another of the various aspects of the disclosure described above.

For example, according to one aspect of the disclosure, there may be provided a method including part or all of five steps: (a) setting up, by the client device, a device driver for wireless communication in a tentative operating environment, wherein the tentative operating environment is a transient operating environment of the client device for performing system recovery; (b) establishing, by the wireless connection device, wireless communication with the client device for performing the system recovery; (c) obtaining, by the wireless connection device, restoration data, wherein restoration data is stored in advance in a specified storage and is used for the system recovery of the client device; (d) sending, by the wireless connection device, the obtained restoration data via the wireless communication to the client device; and (e) performing, by the client device, the system recovery based on the received restoration data. The method may include or may not include the step (a). The method may also include or may not include the step (b). The method may further include or may not include the step (c). The method may also include or may not include the step (d). The method may further include or may not include the step (e). This method is configured to be performed between the client device and the wireless connection device to enable the system recovery of the client device. This method may, however, be configured to be performed between a client device and a wired connection device to enable the system recovery of the client device. This method may also be configured to be performed between a server device and a wireless connection device to enable the system recovery of the server device. Any of such configurations can attain the object of the easy system recovery of the device.

What is claimed is:

1. A wireless connection device, comprising:
circuitry configured to
establish wireless communication with a client device connected with the wireless connection device;
obtain restoration data that is stored in advance in a specified storage, wherein the restoration data is for system recovery of the client device; and
send the obtained restoration data via the wireless communication to the client device.

2. The wireless connection device according to claim 1, wherein the circuitry is configured to:
receive a notification indicating completion of the system recovery from the client device; and
terminate the wireless communication with the client device upon receiving the notification.

3. The wireless connection device according to claim 1, wherein the circuitry is configured to:
obtain authentication information from the client device;
perform authentication of the client device based on the obtained authentication information; and
obtain the restoration data when a result of the authentication indicates that authentication was successful.

4. The wireless connection device according to claim 1, wherein the circuitry is configured to send a computer program for the system recovery to the client device via the wireless communication after the establishment of the wireless communication and before the system recovery.

5. The wireless connection device according to claim 1, wherein the circuitry is configured to store the restoration data received from the client device to the specified storage.

6. The wireless connection device according to claim 1, wherein the specified storage is provided in at least either an auxiliary storage device of the wireless connection device or a storage device connected via a network to the wireless connection device.

7. The wireless connection device according to claim 1, wherein the wireless communication is wireless communication with encryption having less loading than a highest possible encryption allowable in the client device or wireless communication without encryption.

8. A method of recovering of a client device connected with a wireless connection device, the method comprising:
setting up, by the client device, a device driver for wireless communication in a transient operating environment of the client device for performing system recovery;
establishing, by the wireless connection device, wireless communication with the client device;
obtaining, by the wireless connection device, restoration data that is stored in advance in a specified storage, wherein the restoration data is for system recovery of the client device;
sending, by the wireless connection device, the obtained restoration data via the wireless communication to the client device; and
performing, by the client device, the system recovery based on the received restoration data.

9. The method according to claim 8, wherein
the setting up the driver includes accessing a storage medium for starting the client device, the storage medium enabling function of the device driver for wireless communication in the client device.

10. The method according to claim 9, wherein
the storage medium stores a computer program for the system recovery, and
the performing the system recovery includes executing the computer program for system recovery in the client device prior to the system recovery.

11. The method according to claim 8, further comprising:
sending, by the client device, a notification indicating completion of the system recovery to the wireless connection device;
receiving, by the wireless connection device, the notification indicating completion of the system recovery; and
terminating, by the wireless connection device, the wireless communication with the client device.

12. The method according to claim 8, wherein the obtaining the restoration data includes:
obtaining, by the wireless connection device, authentication information from the client device;
performing, by the wireless connection device, authentication of the client device based on the obtained authentication information; and
obtaining, by the wireless connection device, the restoration data from the specified storage when a result of the authentication indicates that authentication was successful.

13. The method according to claim 8, further comprising:
sending, by the wireless connection device, a computer program for the system recovery via the wireless communication to the client device after the establishment of the wireless communication and before the system recovery.

14. The method according to claim 8, further comprising:
replicating, by the client device, information in a memory of the client device;
generating, by the client device, the restoration data based on the replicated information in the memory;
sending, by the client device, the generated restoration data to the wireless connection device; and
storing, by the wireless connection device, the received restoration data in the specified storage.

15. The method according to claim 14, wherein the generating the restoration data includes:
encrypting, by the client device, the replicated information in the memory; and
compressing encrypted data and a decryption key to generate the restoration data.

16. The method according to claim 14, further comprising:
sending, by the wireless connection device to the client device, a computer program for replicating the information in the memory of the client device, generating the restoration data and sending the generated restoration data to the wireless connection device.

17. The method according to claim 8, wherein
the specified storage is provided in at least either an auxiliary storage device of the wireless connection device or a storage device connected via a network to the wireless connection device.

18. The method according to claim 8, wherein
the wireless communication is wireless communication with encryption having less loading than highest possible encryption allowable in the client device or wireless communication without encryption.

19. A non-transitory computer-readable medium including a computer program, which when executed by a computer, causes the computer to:
replicate information in a memory of the computer;
encrypt the replicated information;
compress the encrypted replicated information and a decryption key; and
transmit the compressed information as restoration data to a wireless connection device to which the computer is connected via wireless communication.

20. A non-transitory computer-readable medium including a computer program, which when executed by a computer, cause the computer to:
request a wireless connection device to obtain restoration data, wherein the computer is connected to the wireless connection device via wireless communication;
receive the restoration data from the wireless connection device;
decompress the received restoration data;
decrypt encrypted data included in the decompressed restoration data based on a decryption key included in the decompressed restoration data; and
replicate decrypted data in a memory of the computer to perform system recovery based on the decrypted data.
